(19) United States
(12) Patent Application Publication
(10) Pub. No.: US 2015/0197442 A1
(43) Pub. Date: Jul. 16, 2015

(54) APPARATUS AND METHODS OF MAKING A GLASS TUBE BY DRAWING MOLTEN GLASS

(71) Applicant: Corning Incorporated, Corning, NY (US)

(72) Inventors: Antoine Gaston Denis Bisson, Corning, NY (US); Vladislav Yuryevich Golyatin, Avon (FR); Xavier Tellier, Cheroy (FR)

(21) Appl. No.: 14/422,544

(22) PCT Filed: Aug. 29, 2013
(86) PCT No.: PCT/US13/57179

§ 371 Date: Feb. 19, 2015

Related U.S. Application Data
(60) Provisional application No. 61/694,920, filed on Aug. 30, 2012.

(51) Int. Cl. C03B 17/04

(52) U.S. Cl. CPC C03B 17/04

(57) ABSTRACT

Method and apparatus for making a glass tube 205 comprising the step of flowing molten glass 121 into a trough 201 such that the molten glass includes a free surface 614 within the trough, wherein a portion of the molten glass with a corresponding portion of the free surface overflows an endless weir 613 to form a molten glass tube 205 flowing down a cylindrical surface 603. The glass tube making apparatus comprises an endless weir 613 configured such that a free surface 614 of molten glass 121 within a trough 201 may overflow the endless weir 613 to form a molten glass tube 205 flowing down a cylindrical surface 603.

### CROSS-REFERENCE TO RELATED APPLICATIONS

This application claims the benefit of priority under 35 U.S.C. §119 of U.S. Provisional Application Ser. No. 61/694,920 filed on Aug. 30, 2012, the content of which is relied upon and incorporated herein by reference in its entirety.

### TECHNICAL FIELD

The present invention relates generally to apparatus and methods of making a glass tube and, more particularly, to apparatus and methods of making a glass tube wherein a portion of molten glass with a corresponding portion of a free surface of the molten glass overflows an endless weir to form a molten glass tube.

### BACKGROUND

Conventional methods and apparatus are known to provide glass tubes. For example, glass tubes are known to be formed during an extrusion process, downwardly flowing molten glass over a tapered valve, and flowing molten glass over an outer surface of a cylindrical shell. Such conventional techniques can provide continuous manufacture of glass tubes during the manufacturing process.

### SUMMARY

The following presents a simplified summary of the disclosure in order to provide a basic understanding of some example aspects described in the detailed description.

In accordance with a first example aspect, a method of making a glass tube comprises the step (I) of flowing molten glass into a trough such that the molten glass includes a free surface within the trough, wherein a portion of the molten glass with a corresponding portion of the free surface overflows an endless weir extending along an upstream circumference of a cylindrical surface to form a molten glass tube flowing down the cylindrical surface. The method further includes the step (II) of drawing the molten glass tube off a downstream portion of the cylindrical surface to form a glass tube with a predetermined shape.

In one example of the first aspect, during step (I), the free surface of the molten glass overflowing the endless weir forms an inner surface of the molten glass tube.

In another example of the first aspect, step (I) provides a drain member with the cylindrical surface defining an inner surface of the drain member.

In still another example of the first aspect, step (I) provides the endless weir to circumscribe the cylindrical surface of the drain member.

In another example of the first aspect, during step (I), the free surface of the molten glass overflowing the endless weir forms an outer surface of the molten glass tube.

In another example of the first aspect, step (I) provides a forming device with the cylindrical surface defining an outer surface of the forming device.

In a further example of the first aspect, step (I) further includes adjusting the temperature of the molten glass tube flowing down the cylindrical surface.

In still a further example of the first aspect, the method further comprises the step of adjusting a glass flow distribution overflowing the endless weir by adjusting an angle between the cylindrical surface and the trough.

In an example of the first aspect, the molten glass flowing into the trough during step (I) has a viscosity μ within a range of 10,000 P≦μ≦500,000 P.

In another example of the first aspect, step (II) draws at least a portion of the molten glass tube off at least one edge director positioned at the downstream portion of the cylindrical surface.

In a further example of the first aspect, the predetermined shape of step (II) is circular.

In still a further example of the first aspect, the predetermined shape of step (II) is oblong.

Any examples of the first example aspect may be used alone or in combination with any number of the other examples of the first example aspect discussed above.

In a second example aspect, a glass tube making apparatus comprises a trough configured to receive molten glass and a forming device defining a cylindrical surface. An endless weir extends along an upstream circumference of the cylindrical surface. The endless weir is configured such that a free surface of the molten glass within the trough may overflow the endless weir to form a molten glass tube flowing down the cylindrical surface.

In one example of the second aspect, the forming device comprises a drain member with the cylindrical surface defining an interior surface of the drain member.

In another example of the second aspect, the endless weir circumscribes the cylindrical surface of the drain member.

In still another example of the second aspect, the cylindrical surface defines the outer surface of the forming device.

In another example of the second aspect, the apparatus further comprises a temperature control device configured to adjust the temperature of the molten glass tube flowing down the cylindrical surface.

In yet another example of the second aspect, the forming device is angularly adjustable relative to the trough to adjust a glass flow distribution overflowing the endless weir.

In still another example of the second aspect, the apparatus further comprises at least one edge director mounted with respect to a downstream portion of the forming device.

In another example of the second aspect, the edge director extends downstream from a lower edge of the forming device.

Any examples of the second example aspect may be used alone or in combination with any number of the other examples of the second example aspect discussed above.

### BRIEF DESCRIPTION OF THE DRAWINGS

These and other aspects are better understood when the following detailed description is read with reference to the accompanying drawings, in which:

FIG. 1 is a schematic view of a first portion of a glass tube making apparatus in accordance with aspects of the disclosure;

FIG. 2 is a schematic view of a second portion of the glass tube making apparatus in accordance with aspects of the disclosure;

FIG. 3 is one example cross section along line 3-3 of the glass tube of FIG. 2 illustrating an example oblong predetermined cross-sectional shape of the glass tube;

FIG. 4 is another cross section along line 3-3 of the glass tube of FIG. 2 illustrating another example oblong predetermined cross-sectional shape of the glass tube;

FIG. 5 is another cross section along line 3-3 of the glass tube of FIG. 2 illustrating an example circular predetermined cross-sectional shape of the glass tube;

FIG. 6 is a cross section along line 6-6 of FIG. 2 illustrating portions of an example forming device of the glass tube making apparatus of FIGS. 1-2;

FIG. 7 is a top view of FIG. 6; and

FIG. 8 is a schematic view of another second portion of the glass tube making apparatus in accordance with further aspects of the disclosure.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

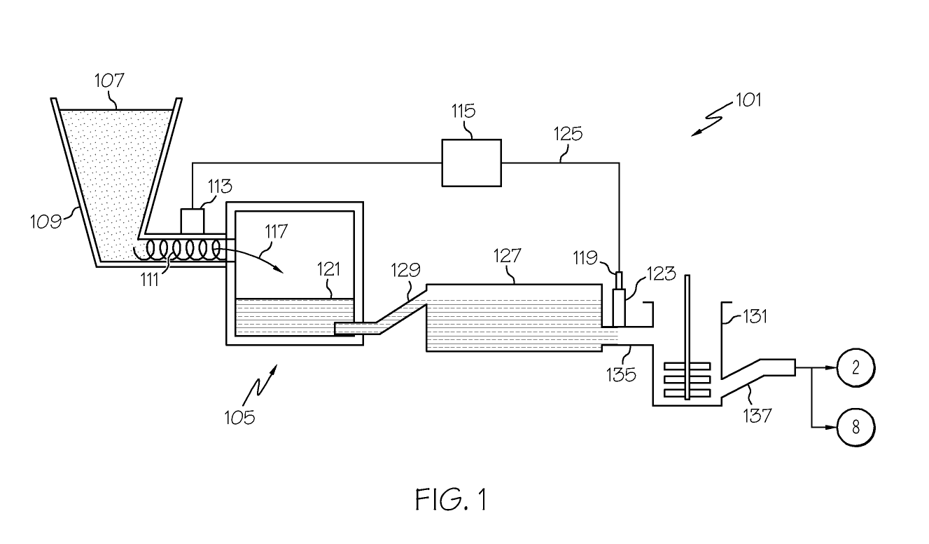

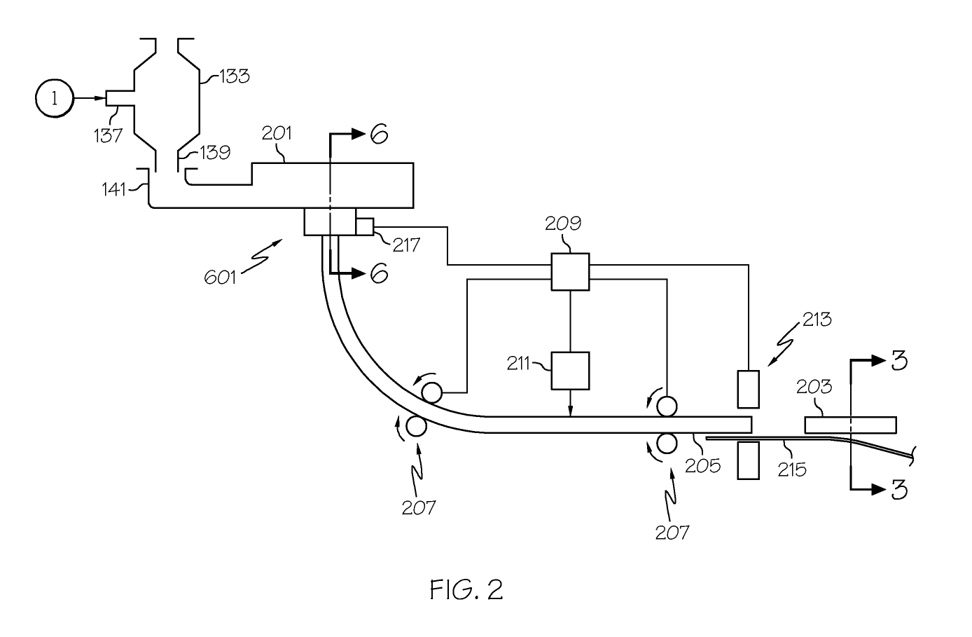

FIGS. 1 and 2 illustrate a schematic view of portions of a glass tube making apparatus 101 for manufacturing a glass tube with a predetermined shape for various applications. FIG. 1 illustrates an upstream portion of the glass tube making apparatus 101 while FIG. 2 illustrates a downstream portion of the glass tube making apparatus 101. As shown in FIG. 1, the glass tube making apparatus 101 can include a melting vessel 105 configured to receive batch material 107 from a storage bin 109. The batch material 107 can be introduced by a batch delivery device 111 powered by a motor 113. An optional controller 115 can be configured to activate the motor 113 to introduce a desired amount of batch material 107 into the melting vessel 105, as indicated by arrow 117. In one example, a glass metal probe 119 can be used to measure a molten glass 121 level within a standpipe 123 and communicate the measured information to the controller 115 by way of a communication line 125.

The glass tube making apparatus 101 can also include a fining vessel 127, such as a fining tube, located downstream from the melting vessel 105 and coupled to the melting vessel 105 by way of a first connecting tube 129. A mixing vessel 131, such as a stir chamber, can also be located downstream from the fining vessel 127. As illustrated in FIG. 2, a delivery vessel 133, such as a bowl, may be located downstream from the mixing vessel 131. As shown, a second connecting tube 135 can couple the fining vessel 127 to the mixing vessel 131 and a third connecting tube 137 can couple the mixing vessel 131 to the delivery vessel 133. As further illustrated, a downcomer 139 can be positioned to deliver molten glass 121 from the delivery vessel 133 to an inlet 141 of a trough 201. As shown, the melting vessel 105, fining vessel 127, the mixing vessel 131, delivery vessel 133, and trough 201 are examples of molten glass stations that may be located in series along the glass tube making apparatus 101.

As shown in FIG. 2, an elongated glass tube 205 may be continuously drawn from the forming device 601, for example, by one or more drive rollers 207 that may be driven under the command of a controller 209 to obtain a proper drawing speed of the elongated glass tube 205 from the forming device 601. An inspection device 211 may be used to help determine the thickness of the wall of the elongated glass tube 205 although the inspection device 211 may be used to measure other characteristics in further examples. Feedback from the inspection device 211 may be used as feedback to the controller 209. The controller can then send command signals to the drive rollers 207 to help adjust the characteristics (e.g., wall thickness) of the elongated glass tube 205 being drawn from the forming device 601. The drive rollers 207 can be located in a position where the shape of the glass tube has already been frozen into place. Alternatively, the drive rollers 207 can be located in a location where the rollers can help deform the glass tube to a final shape before the glass tube is frozen into the final shape configuration.

As further shown in FIG. 2, the elongated glass tube 205 maybe continuously drawn and periodically cut by a cutting device 213 into glass tube segments 203 that may be moved by a conveyor 215 or other material handling device to a remote location for storage or further processing.

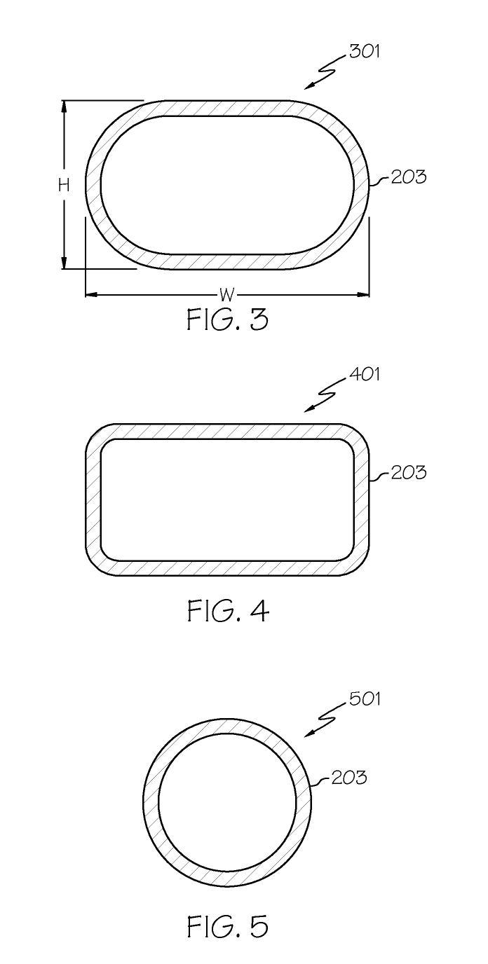

As shown in FIGS. 3-5, the forming device 601 can be designed to produce glass tubes having a wide range of cross-sectional shapes. In one example, the glass tubes can have an oblong shape, such as an oval shape, an egg shape, a rectangular shape, or other oblong shape. FIG. 3 shows the glass tube 203 including an oblong shape comprising an oval shape 301. FIG. 4 shows the glass tube 203 including another oblong shape comprising a rectangular shape 401 although other oblong shapes may be provided in further examples. FIG. 5 further shows the glass tube 203 including a circular cross sectional shape 501. Other tube shapes may be provided in further examples such as a polygonal shape with three or more sides or other tube shape configurations. Aspects of the disclosure can produce cross-sectional shapes having various aspect ratios. By way of reference to FIG. 3, the cross-sectional aspect ratio of the glass tube can be considered the Width “W” relative to the height “H”. For instance, if the width “W” shown in FIG. 3 is twice as large as the height “H”, the cross-sectional aspect ratio of the glass tube would be 2:1. In some examples, glass tubes formed with apparatus and by methods of the disclosure can include aspect ratios from about 1:1 to about 10:1 although glass tubes including cross-sectional shapes with other alternative aspect ratios may be provided in further examples. Still further, glass tubes may have a wide range of sizes. By way of example, glass tubes may have a width “W” of from about 50 mm to about 100 mm although other width sizes may be provided in further examples.

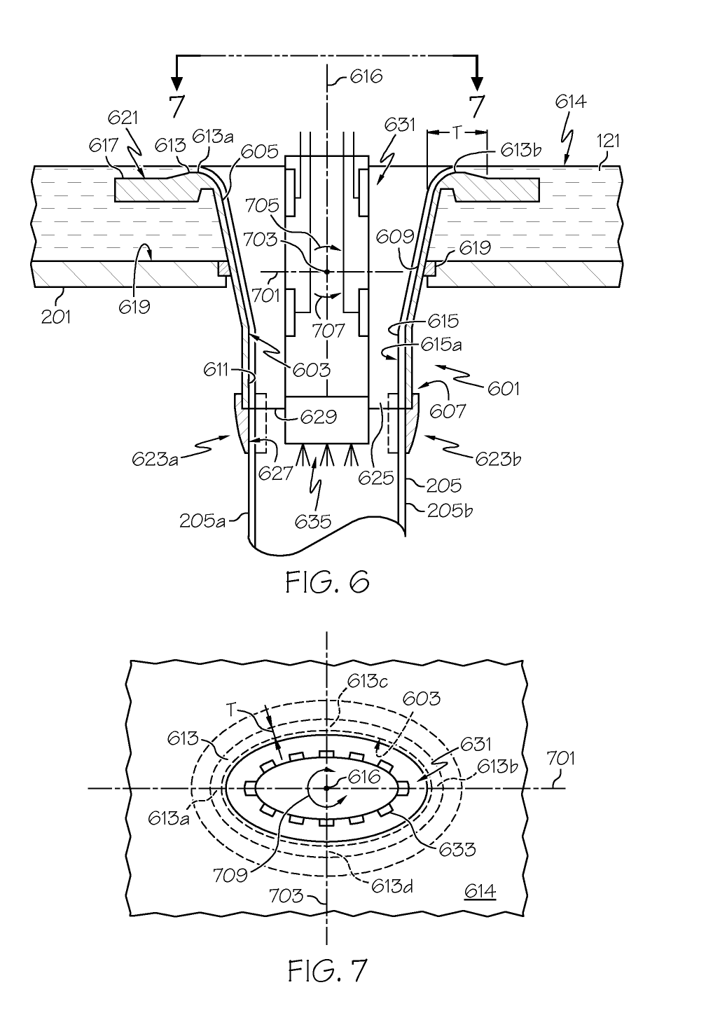

FIG. 6 is a cross section along line 6-6 of FIG. 2 illustrating portions of an example forming device 601 of the glass tube making apparatus 101. As shown in FIG. 6, in one example, the forming device 601 can comprise a drain member with a cylindrical surface 603 defining an interior surface of the drain member. The cylindrical surface 603 can include and upstream circumference 605 and a downstream portion 607. As shown, the cylindrical surface 603 can comprise a frustoconical portion 609 in an upstream portion of the cylindrical surface 603 and a cylindrical portion 611 within a downstream portion of the cylindrical surface 603. While the cylindrical surface 603 is shown to include a tapering frustoconical portion that transitions into a non-tapering cylindrical portion, various other configurations maybe provided. For example, substantially the entire cylindrical surface 603 may comprise a tapered frustoconical portion or a non-tapered cylindrical portion. Furthermore, cylindrical surface 603 can include a wide range of shape configurations to facilitate formation of the predetermined shape of the tube and control the thickness of the tube walls. Modeling techniques and/or experiments maybe conducted to determine the optimal features of the cylindrical surface 603 to obtain the desired glass tube with predetermined shape.

As further illustrated in FIG. 6, the forming device 601 can also include an endless weir 613 extending along the upstream circumference 605 of the cylindrical surface 603. The endless weir 613 is configured such that a free surface 614 of the molten glass 121 within the trough 201 may overflow the endless weir 613 to form a molten glass tube 615 flowing down the cylindrical surface 603 such that an inner surface 615a of the molten glass tube 615 is defined by the free surface 614 of the molten glass 121 flowing over the endless weir 613. The trough 201 can be considered any structure configured to provide the free surface 614. The weir 613 can be considered at least a circumferential apex portion that the free surface 614 is configured to flow over. As such, the free surface 614 may freely flow over the endless weir 613 to form a pristine inner surface 615a of the glass tube 615 that has not be contacted by another solid object when forming the pristine inner surface 615a. As such, the inner pristine surface 615a may be free from streaks, scratches, inclusions or other surface imperfections that may otherwise diminish the quality of the inner surface of the glass tube.

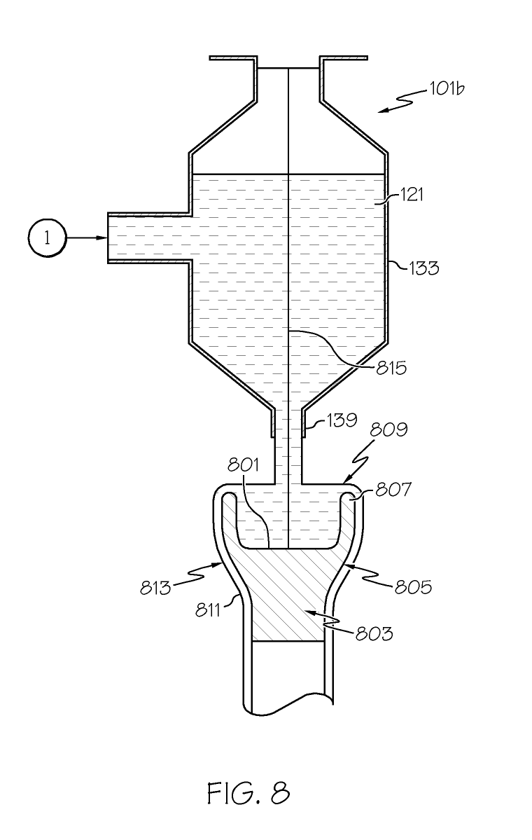

As shown, the endless weir can circumscribe the cylindrical surface of the drain member. For example, as shown in FIGS. 6-7, the endless weir 613 can circumscribe the entire cylindrical surface 603 of the drain member 601. As further shown in FIG. 7, the endless weir 613 can include a shape that is geometrically similar, such as identical to the shape of the cylindrical surface 603 while circumscribing the entire cylindrical surface 603.

As shown in FIG. 6, the weir is endless in that the weir comprises a ring with no beginning or end. The endless weir 613 can be configured such that a free surface 121 of the molten glass 121 within the trough 201 may overflow the endless weir 613 to form a molten glass tube 615 flowing down the cylindrical surface 603. As shown in FIGS. 6 and 7, the endless weir 613 can include a radial thickness “T” along a radial direction towards an axis 616 of the cylindrical surface 603. Like the features of the cylindrical surface 603, the radial thickness “T” and other features of the endless weir 613 can also be adjusted to provide desireable flow characteristics to enhance the quality of the glass tube. The endless weir 613 can include a ring extending along various alternative paths. For example, although not required, the endless weir 613 may include a ring extending along a path having a shape that is geometrically similar, such as substantially identical to the cross sectional shape of the glass tube. For example, as shown in FIG. 7, the endless weir 613 may include an oval shape that is larger than, but geometrically similar to, the oval shape 301 of the glass tube 203 shown in FIG. 3.

An optional landing 617 may extend radially outward from the endless weir 613 although the illustrated landing 617 may not be provided in further examples. Moreover, in some examples, the landing 617 may optionally be flush or otherwise incorporated in with the bottom surface 619 of the trough 201. For instance, the upwardly facing surface 621 of the illustrated landing 617 may comprise the bottom surface 619 of the trough 201 or may be designed to be flush with the bottom surface 619 of the trough 201.

As further illustrated in FIG. 6, the forming device, such as the illustrated drain member 601, can be angularly adjustable relative to the trough 201 to adjust a glass flow distribution overflowing the endless weir 613. For example, with reference to FIG. 7, the drain member may be angularly adjusted relative to a first axis 701 and/or a second axis 703 of the trough 201 to adjust the flow distribution overflowing the endless weir. For example, if the inspection device 211 determines a first wall portion 205a is too thick relative to a second wall portion 205b, the controller 209 may send a signal to an actuator 217 (see FIG. 2) to automatically tilt the drain member 601 in direction 705 about the second axis 703. As such, a relatively restricted flow would be achieved over a first weir portion 613a when compared to a second weir portion 613b. As such, the thickness of the first wall portion 205a can be reduced when compared to the second wall portion 205b to correct for undesirable differences in wall thicknesses. Likewise, if the inspection device 211 determines a first wall portion 205a is too thin relative to a second wall portion 205b, the controller 209 may send a signal to an actuator 217 (see FIG. 2) to automatically tilt the drain member 601 in direction 707 about the second axis 703. As such, a relatively unrestricted flow would be achieved over a first weir portion 613a when compared to a second weir portion 613b. As such, the thickness of the first wall portion 205a can be increased when compared to the second wall portion 205b to correct for undesirable differences in wall thicknesses. Similar adjustments may be made by the actuator to correct for relative differences in thicknesses of the glass tube resulting in molten glass overflowing a third and/or fourth portion 613c, 613d of the endless weir 613 as shown in FIG. 7 by adjusting the drain member 601 about the first axis 701. Still further, rotational adjustments of the drain member 601 in a clockwise or counterclockwise direction 709 about axis 616 may be further carried out to achieve the desired molten glass flow profile over the endless weir 613.

As discussed above, the adjustment of the drain member 601 may be carried out automatically with the actuator 217 being controlled by the controller 209. In further examples, the drain member 601 may be installed at a desired adjusted angle that may be changed at a later time. For example, an adapter 619 may be installed to mount the drain member 601 at a desired angular orientation relative to the trough 201. In further examples, the illustrated adapter 619 may be replaced with another adapter to provide a different desired angular orientation relative to the trough 201.

As further illustrated in FIG. 6, the apparatus can include at least one edge director 623a, 623b mounted with respect to a downstream portion 625 of the forming device 601. As shown, the edge directors can be designed to only extend about part of the periphery of the downstream portion 625. As shown, a curved surface segment 627 can extend flush with respect to the corresponding portions of the cylindrical surface 603. As such, the edge directors 623a, 623b can extend downstream from a lower edge 629 of the downstream portion 625 to increase the overall effective cylindrical surface at predetermined locations of the downstream portion 625. Such edge directors can help guide the flow and limit the loss of width and bring more stability to the draw occurring below the lower edge 629 of the downstream portion 625. The edge directors, if provided, can be made from refractory ceramic but can also be made from precious metals (e.g. platinum) in further examples.

The apparatus 101 can further include a temperature control device 631 that may have a plurality of temperature control elements 633 configured to be operated together or independently to provide a desired temperature profile about a periphery of the molten glass tube 615 flowing down the cylindrical surface 603. In one example, one or more of the temperature control elements comprise cooling elements. In another example, one or more of the temperature control elements comprise heating elements. Still further, the temperature control device 631 can include both heating and cooling elements configured to be operated together or independently to help control the temperature profile about the periphery of the glass tube 615. For example, as shown in FIG. 7, the plurality of temperature control elements 633 can be radially arranged to independently control the temperature of predetermined radial locations of the glass tube. As such, a desired temperature profile can be achieved about the periphery of the glass tube to help control thickness and other attributes of the glass tube. Similarly, a temperature control device may be provided, for example, above the weir to control the temperature profile of the free surface as it spills over the weir and/or control the temperature profile of the glass flowing down the cylindrical surface. As such, a desired temperature profile can also be achieved at the free surface flowing over the weir and/or along the cylindrical surface to help control thickness and other attributes of the glass tube. In one example, the controller 209 may be designed to operate the temperature control device 631 based on feedback from the inspection device 211 to allow temperature adjustments to facilitate control of characteristics of the glass tube, such controlling thickness variations in the glass tube.

As shown in FIG. 6, a pressure device 635, such as the illustrated pressurize air ports may be configured to provide a predetermined pressure within the interior of the glass tube. In the illustrated example, the pressure device can be integrated with the temperature control device 631. In further examples, the pressure device 635 may be provided separately or alternatively to the temperature control device. The pressure device 635, if provided may provide an overpressure of from about 0 millibars to about 50 millibars, such as from about 20 millibars to about 30 millibars although any desired pressure may be provided within the interior area of the tube.

FIG. 8 is a schematic illustration of an alternative glass tube making apparatus 101b including a trough 801 integrated with a forming device 803 including an outer surface comprising a cylindrical surface 805. The apparatus 101b further includes an endless weir 807.

The endless weir 807 is configured such that a free surface 809 of the molten glass 121 within the trough 801 may overflow the endless weir 807 to form a molten glass tube 811 flowing down the cylindrical surface 805 such that an outer surface 813 of the molten glass tube 811 is defined by the free surface 809 of the molten glass flowing over the weir 807. As such, the free surface 809 may freely flow over the endless weir 807 to form a pristine outer surface 813 of the glass tube 811 that has not be contacted by another solid object when forming the pristine outer surface 813. As such, the outer pristine surface 813 may be free from streaks, scratches, inclusions or other surface imperfections that may otherwise diminish the quality of the outer surface of the glass tube. As shown, in one example, a support member 815 may hang the forming member 803 and trough 801 below the mixing vessel 131.

The forming devices 601, 803 and other elements of the apparatus can comprise refractory ceramic machined to the desired shape (e.g., alumina or zirconia). In further examples, precious metal clad can also be used with various glass compositions. In some examples, a complete precious metal delivery may also be provided.

Methods of making a glass tube will now be described. Initially, molten glass 121 may be produced, for example, with portions of a glass tube making apparatus 101 shown in FIG. 1. Next, in one example, the molten glass 121 may enter an inlet 141 of a trough 201 as shown in FIG. 2. In one example the molten glass flowing into the trough 201 includes a viscosity μ within a range of 10,000 P≦μ≦500,000 P, such as 50,000 P≦μ≦400,000 P. As shown in FIG. 6, molten glass can flow into the trough 201 such that the molten glass 121 includes a free surface 614 within the trough 201. Next, a portion of the molten glass 121 with a corresponding portion of the free surface 614 overflows the endless weir 613 to form the molten glass tube 615 flowing down the cylindrical surface 603.

In the example shown in FIG. 6, the free surface 614 of the molten glass 121 overflowing the endless weir 613 forms the inner surface 615a of the molten glass tube 615.

As such, the glass tube 615 may be provided with a pristine inner surface 615a that has not be contacted by another solid object when forming the pristine inner surface 615a. As such, the inner pristine surface 615a may be free from streaks, scratches, inclusions or other surface imperfections that may otherwise diminish the quality of the inner surface of the glass tube.

In another example, as shown in FIG. 8, the molten glass 121 may enter pass down from the downcomer 139 to flow into the trough 801 such that the molten glass 121 includes a free surface 809 within the trough 801. In one example the molten glass flowing into the trough 801 includes a viscosity μ within a range of 10,000 P≦μ≦500,000 P, such as 50,000 P≦μ≦400,000 P. Next, a portion of the molten glass 121 with a corresponding portion of the free surface 809 overflows the endless weir 807 to form the molten glass tube 811 flowing down the cylindrical surface 805. In the example shown in FIG. 8, the free surface 809 of the molten glass 121 overflowing the endless weir 807 forms the outer surface 813 of the molten glass tube 811. As such, the glass tube 811 may be provided with a pristine outer surface 813 that has not be contacted by another solid object when forming the pristine outer surface 813. As such, the outer pristine surface 813 may be free from streaks, scratches, inclusions or other surface imperfections that may otherwise diminish the quality of the inner surface of the glass tube

In the example shown in FIG. 8, the free surface 809 of the molten glass 121 overflowing the endless weir 807 forms the outer surface 813 of the molten glass tube 811.

As such, the glass tube 811 may be provided with a pristine outer surface 813 that has not been contacted by another solid object when forming the pristine outer surface 813. As such, the outer pristine surface 813 may be free from streaks, scratches, inclusions or other surface imperfections that may otherwise diminish the quality of the inner surface of the glass tube.

In the examples of FIGS. 6 and 8, various techniques may be used to help control the thickness, dimensions and/or quality of the glass tube being drawn from the forming device. For example, the method can include the step of adjusting the temperature of the molten glass tube 615, 811 flowing down the cylindrical surface 603, 805. A temperature control device (e.g., see 631 in FIG. 6) may be used although other temperature control devices may be used in further examples to selectively adjust portions of the molten glass tube. Such localized precise temperature control can effect flow of the molten glass and therefore may help fine tune the thickness of the glass tubes in that area. As such, localized temperature control can help fine tune thickness control of the glass tube about the periphery of the tube. Temperature control can be carried out on several independent zones surrounding the delivery to obtain desired thickness uniformity, for example. Cooling blocks such as air cooled boxes, high temperature heat pipes and/or direct impinging jets may be used to influence locally the temperature of the glass (e.g., by radiation and/or convection) to change the flow distribution appropriately.

The examples of FIGS. 6 and 8 can also include the optional step of adjusting a glass flow distribution overflowing the endless weir 613, 807 by adjusting an angle between the cylindrical surface 603, 805 and the trough 201, 801. Adjusting may occur manually or automatically, for example, as discussed with respect to the example of FIG. 6 discussed above.

As such, FIGS. 6 and 8 demonstrate methodologies that may help control the thickness and/or quality of the glass tube being drawn off the forming device. For example, referring to FIG. 2, the method can include the step of inspecting the drawn glass tube 205 for tube characteristics (e.g., thickness). Based on the measured values, the controller 209 may adjust the drive rollers 207 and/or the tilt angle between the cylindrical surface and the trough. In some examples, the apparatus (e.g., by way of the controller 209 and inspection device 211) may be designed to provide a glass tube with a substantially constant thickness about the periphery of the glass tube. In further examples, portions of the glass tube may be selected to be thicker than other portions of the glass tube. As such, in further examples, apparatus of the present invention can also provide differing thicknesses of the glass tube about the periphery of the glass tube.

As mentioned with respect to FIG. 6 above, the glass tube 615 may be provided with a pristine inner surface 615a that is substantially free from streaks, scratches, inclusions or other surface imperfections that may otherwise diminish the quality of the inner surface of the glass tube. Providing an inner pristine surface can be desireable to minimize undesirable distortions of light passing through the glass tube from a display device positioned within the tube. For example, glass tubes of the present disclosure may be used as a housing for an electronic device (e.g., a smartphone or other hand-held device). Images from the display may freely pass through the pristine inner surface 615a without being obscured by streaks, scratches, inclusions or other imperfections that may otherwise exist.

As mentioned with respect to FIG. 8 above, the glass tube 811 may also be provided with a pristine outer surface 813 that may be substantially free from streaks, scratches, inclusions or other surface imperfections that may otherwise diminish the quality of the inner surface of the glass tube. Providing an outer pristine surface may be desirable to help reduce interruption of optical imperfections of light entering or leaving the outer surface of the glass tube.

It will be apparent to those skilled in the art that various modifications and variations can be made without departing from the spirit and scope of the claimed invention.

1. A method of making a glass tube comprising the steps of:
(I) flowing molten glass into a trough such that the molten glass includes a free surface within the trough, wherein a portion of the molten glass with a corresponding portion of the free surface overflows an endless weir extending along an upstream circumference of a cylindrical surface to form a molten glass tube flowing down the cylindrical surface; and
(II) drawing the molten glass tube off a downstream portion of the cylindrical surface to form a glass tube with a predetermined shape.

2. The method of claim 1, wherein, during step (I), the free surface of the molten glass overflowing the endless weir forms an inner surface of the molten glass tube.

3. The method of claim 1, wherein step (I) provides a drain member with the cylindrical surface defining an inner surface of the drain member.

4. The method of claim 3, wherein step (I) provides the endless weir to circumscribe the cylindrical surface of the drain member.

5. The method of claim 1, wherein, during step (I), the free surface of the molten glass overflowing the endless weir forms an outer surface of the molten glass tube.

6. The method of claim 1, wherein step (I) provides a forming device with the cylindrical surface defining an outer surface of the forming device.

7. The method of claim 1, wherein step (I) further includes adjusting the temperature of the molten glass tube flowing down the cylindrical surface.

8. The method of claim 1, further comprising the step of adjusting a glass flow distribution overflowing the endless weir by adjusting an angle between the cylindrical surface and the trough.

9. The method of claim 1, wherein the molten glass flowing into the trough during step (I) has a viscosity μ within a range of 10,000 P≦μ≦500,000 P.

10. The method of claim 1, wherein step (II) draws at least a portion of the molten glass tube off at least one edge director positioned at the downstream portion of the cylindrical surface.

11. The method of claim 1, wherein the predetermined shape of step (II) is circular.

12. The method of claim 1, wherein the predetermined shape of step (II) is oblong.

13. A glass tube making apparatus comprising:
a trough configured to receive molten glass;
a forming device defining a cylindrical surface; and
an endless weir extending along an upstream circumference of the cylindrical surface,
wherein the endless weir is configured such that a free surface of the molten glass within the trough may overflow the endless weir to form a molten glass tube flowing down the cylindrical surface.

14. The apparatus of claim 13, wherein the forming device comprises a drain member with the cylindrical surface defining an interior surface of the drain member.

15. The apparatus of claim 13, wherein the endless weir circumscribes the cylindrical surface of the drain member.

16. The apparatus of claim 13, wherein the cylindrical surface defines the outer surface of the forming device.

17. The apparatus of claim 13, further comprising temperature control device configured to adjust the temperature of the molten glass tube flowing down the cylindrical surface.

18. The apparatus of claim 13, wherein the forming device is angularly adjustable relative to the trough to adjust a glass flow distribution overflowing the endless weir.

19. The apparatus of claim 13, further comprising at least one edge director mounted with respect to a downstream portion of the forming device.

20. The apparatus of claim 19, wherein the edge director extends downstream from a lower edge of the forming device.
